(19) United States
(12) Patent Application Publication
(10) Pub. No.: US 2023/0041604 A1
(43) Pub. Date: Feb. 9, 2023

(54) ELECTROCHEMICAL SODIUM METAL HALIDE BATTERY, AND METHOD FOR PRODUCING SAME

(71) Applicant: Fraunhofer-Gesellschaft zur Foerderung der angewandten Forschung e.V., Muenchen (DE)

(72) Inventor: Martin HOFACKER, Jena (DE)

(21) Appl. No.: 17/787,851

(22) PCT Filed: Dec. 22, 2020
(86) PCT No.: PCT/DE2020/101085

§ 371 Date: Aug. 26, 2022

(30) Foreign Application Priority Data
Dec. 23, 2019 (DE) 10 2019 135 752.7

(51) Int. Cl. H01M 4/76; H01M 10/39; H01M 4/75; H01M 4/66; H01M 10/0562

(52) U.S. Cl. CPC H01M 4/762; H01M 10/399; H01M 4/75; H01M 4/661; H01M 10/0562; H01M 2300/008; H01M 2220/20

(57) ABSTRACT

A sodium nickel chloride battery for high-performance batteries of electric vehicles and other demanding stationary applications. The battery which permits a current collector with a maximum surface-to-cross-section ratio and simple manufacture thereof as well as simplified electrode filling of the battery includes a cathode-side metallic current collector elongated in a cathode chamber about a central axis that is made of a metal tube with high electrical conductivity and has, in a part of the current collector immersed in a separator, a formed tube section, provided with elements for increasing the surface area of the current collector, and has, at a transition from an unpressed tube section as a filler tube to a pressed tube section, a through-hole opening the filler tube to the outside, so that the filler tube can be used as a filling opening for the porous mixture of the cathode and the secondary electrolyte.

### PRIORITY CLAIM

The present application is a National Phase entry of PCT Application No. PCT/DE2020/101085, filed Dec. 22, 2020, which claims priority to German Patent Application No. 10 2019 135 752.7, filed Dec. 23, 2019, the disclosures of which are hereby incorporated by reference herein in their entirety.

### FIELD OF THE INVENTION

The invention relates to an electrochemical sodium metal halide battery comprising a housing with a central axis, a separator extending about the central axis of the housing equidistantly from the housing, which separator, as a solid primary electrolyte, electrically insulates and hermetically separates an anode chamber from a cathode chamber, but is permeable to sodium ions; a cathode filling the cathode chamber and consisting of a porous mixture of metal powder and metal halide powder granules, and a secondary electrolyte of molten sodium metal halide salt impregnating the cathode chamber and the porous mixture of the cathode, and a cathode-side metallic current collector elongated about the central axis in the cathode chamber, as well as a process for producing the electrochemical battery. The application of the invention is preferably as a sodium metal halide battery, in particular a sodium nickel chloride battery in high-performance batteries for electric vehicles and demanding stationary applications.

The aforementioned electrochemical batteries contain an anode consisting of at least one metal in the charged state and a cathode generally provided in porous form from transition metals and metal halides (e.g. sodium, nickel, iron, copper, aluminum), which is impregnated with a molten salt for ion conduction that is liquid at least in the operating state, and a metallic current collector for electrical contacting of the cathode.

### BACKGROUND

It is known from the prior art of accumulators or secondary batteries that electrochemical batteries based on sodium metal halide chemistry are used in particular for high-performance batteries in electric vehicles and demanding stationary applications because they have high specific power, energy densities and a long cycle life. Said batteries are thermal batteries in which the anode is formed by a thermally liquefied alkali metal (sodium) and the cathode is formed by a molten liquid salt impregnating a porous material of metals and metal halides (e.g. nickel chloride and sodium chloride), and the two electrodes are separated by an electrically insulating separator which acts as a solid electrolyte (e.g. sodium β-aluminate with the largest possible β″ phase, which conducts sodium ions very well at 270° C. or higher, i.e. is permeable to sodium ions). Such batteries do not exhibit electrochemical self-discharge and have an energy efficiency of approx. 90% and a Coulombic efficiency of 100%.

In this context, US 2015/0004456 A1 describes a current collector for a sodium metal halide battery in which a lamellar design of the current collector is intended to provide high performance and cost savings of the electrochemical batteries. The current collector has at least one flat elongated fin of electrically conductive material, has a bend with respect to its dominant longitudinal axis, and has the bent upper end welded or brazed to a flat metal ring that allows the current collector to be attached to the battery lid with the fin(s) precisely centered along the battery axis. In a preferred embodiment, two complementarily slotted lamellae are arranged crossed with the center kept free for a carbon felt. However, a disadvantage in all the different forms of the current collector is the need to connect the lamellae to the metal ring in a cohesive and precisely aligned manner, and also the fact that a carbon felt of not inconsiderable dimensions has to be positioned between the metal sheets for the storage of the liquid molten salt, said felt being fixed in its position only to a limited extent. As the carbon felt itself occupies space, the electrical storage capacity of the Na/MCl₂ battery is reduced. An imprecisely positioned carbon felt results in locally different current densities, due to cathode regions of different thicknesses, and thus battery properties may vary from battery to battery.

### SUMMARY OF THE INVENTION

It is the object of the invention to find a new way of providing an electrochemical sodium metal halide battery, which allows the current collector to be designed with a maximum surface-to-cross-section ratio, while allowing its alignment along the symmetry axis of the electrochemical battery to achieve uniform current density distribution in the electrode around the current collector and technologically simple manufacturing thereof, as well as simplified assembly of the electrochemical sodium metal halide battery in terms of filling it with the electrode components. An extended object of the invention is to integrate the function of spatial intermediate storage of the molten salt into the current collector.

According to the invention, the object is achieved by an electrochemical sodium metal halide battery comprising a housing with a central axis, a separator extending about the central axis of the housing equidistantly from the housing, which separator, as a solid primary electrolyte, electrically insulates and hermetically separates an anode chamber from a cathode chamber, but is permeable to sodium ions, a cathode filling the cathode chamber and consisting of a porous mixture of metal powder and metal halide powder granules, and a secondary electrolyte of molten sodium metal halide salt impregnating the cathode chamber and the porous mixture of the cathode, and a cathode-side metallic current collector elongated about the central axis in the cathode chamber, characterized in that the current collector is a metal tube having a high electrical conductivity of σ>10⁶ S/m, which is immersed in the porous mixture of granules of the cathode located in the separator and in the secondary electrolyte and is designed as a pressed tube section which is narrowed on the inside in such a way that no granules of the cathode but only secondary electrolyte can penetrate, and is provided on the outside with elements for increasing the surface area of the current collector, and in that the current collector has, above the immersed, pressed tube section, an unpressed tube section as a filler tube for filling the cathode chamber, wherein at least one through-hole opening the filler tube to the outside is provided at a transition from the pressed tube section to the unpressed tube section of the filler tube, so that the filler tube can be used for filling the porous mixture of granules of the cathode into the cathode chamber only outside the pressed tube section and for filling the entire cathode chamber with secondary electrolyte.

Advantageously, the current collector has a carbon felt in the pressed tube section that was inserted into the pressed tube section before pressing.

Conveniently, the current collector has a carbon felt in the pressed tube section that is laterally insertable into the pressed tube section after pressing and removal of a crimped edge of the pressed tube section.

Preferably, the current collector has punched holes, preferably in the form of through-holes, in the pressed tube section as elements for surface enlargement. In this case, the current collector has metal tufts of metal strips or wires in the pressed tube section, which are suitably fastened in the through-holes and made of a metal not attacked by the electrochemical processes of the battery and having a conductivity comparable to that of the metal tube of the current collector.

Conveniently, a commercially available nickel, aluminum or copper tube is used as the current collector.

In the current collector, the elements for surface enlargement are formed with at least one element from the group of punched through-holes or other relief-forming structures with crimped edges, metal tufts, fins or folded metal sheets. In this case, the metal tufts are preferably made of metal strips or wires of nickel or molybdenum.

It proves particularly advantageous if the metal tufts of metal strips or wires are oriented so that local resistance gradients in the cathode chamber are minimized or uniformly distributed across the cross-section of the cathode chamber.

In a further advantageous embodiment, the metal strips or wires used in the metal tufts have a length which is selected to be smaller the higher the capacities of the battery to be achieved are and to be larger, up to the separator at maximum, the higher the powers to be extracted from the battery are.

Preferably, after the porous mixture of the cathode and the secondary electrolyte have been filled, the unpressed tube section of the filler tube of the current collector is sealed with a cohesively bonded circular sheet metal blank or a deep-drawn part. Alternatively, it is convenient for the unpressed tube section of the filler tube of the current collector to be crimped or hermetically sealed with a soldered or welded seam at the upper tube end of the filler tube after the porous mixture of the cathode and the secondary electrolyte have been filled. Preferably, the pressed tube section of the current collector can be pressed flat by applying force from two collinear directions.

In another advantageous embodiment, the pressed tube section of the current collector is pressed from at least three directions equally offset about the central axis to form a star-shaped cross-section.

The pressed tube section of the current collector is preferably pressed by the above-mentioned force effects in such a way that an interior space forming as a secondary electrolyte reservoir is just as large as a volume of secondary electrolyte which is necessary for complete wetting of the current collector in the fully charged state of the battery.

It also proves useful if a metal tube is added below the pressed tube section of the current collector, which metal tube is fitted with radial fins inserted into tangentially equidistant slots of the metal tube.

In another advantageous embodiment, a metal tube with radial fins is added below the pressed tube section of the current collector, which is produced from an equidistantly folded metal sheet and its axially symmetrical bending.

Furthermore, the object is achieved by a method for manufacturing an electrochemical sodium metal halide battery comprising the steps of:
providing a housing for forming an anode chamber, a separator insertable equidistantly from the housing as an electrically insulating solid primary electrolyte permeable only to sodium ions for separating the anode chamber from a cathode chamber, a cathode comprising a porous mixture of metal powder and metal halide granules, and a secondary electrolyte for impregnating the porous mixture of the cathode,
producing a cathode-side current collector from a metal tube which is formed, by forces acting radially on a central axis, into a compressed tube section of the current collector and in which an unpressed tube section remains at the upper end as a filler tube, a through-hole being made at least at a transition from the pressed tube section to the filler tube, which through-hole is provided as an outlet opening of the filler tube for filling the cathode chamber,
producing a battery closure from a cathode closure part having a central opening for passage of the filler tube of the current collector in the central opening of the cathode closure part, and cohesively connecting the cathode closure part to an insulator joining ring as well as cohesively joining an anode closure part to the insulator joining ring,
positioning the current collector collinearly with the central axis in the separator as well as the housing arranged equidistantly around the separator by means of the battery closure consisting of the insulator joining ring and the anode closure part by means of a one-step joining process as well as cohesively connecting the joints,
filling the porous mixture of metal powder and metal halide powder granules of the cathode through the filler tube of the current collector and the at least one through-hole of the filler tube into the cathode chamber in the separator only outside the current collector, and then pouring the secondary electrolyte in liquid form in the absence of oxygen, and
finally hermetically sealing the electrochemical battery by cohesively closing the filler tube.

Conveniently, elements for increasing the surface area of the current collector are introduced equidistantly into the pressed tube section in the form of through-holes. However, they can also be introduced into an unpressed tube section and/or formed as elements from the group of other relief-forming structures with crimped edges, metal tufts, fins or folded metal sheets in the pressed or unpressed tube section.

It proves particularly advantageous to insert metal tufts of metal strips or wire into the through-holes.

The pressed tube section of the current collector is preferably formed flat by collinear radial force application.

In an alternative variant, the pressed tube section of the current collector is advantageously formed into a star shape by several radial forces distributed equally around the central axis.

In another preferred embodiment of the current collector, radial fins are attached to the metal tube below the pressed tube section to increase the surface area of the current collector; these fins are inserted into tangentially equidistant slots.

Furthermore, to increase the surface area of the current collector below the pressed tube section, radial fins can be created on the metal tube by a folded metal sheet that is either wound around the metal tube or bent itself to form a body with a tubular interior.

Conveniently, the filler tube is closed by welding or soldering the upper tube end to a circular sheet metal blank. Alternatively, however, the filler tube can also be closed by crimping the upper tube end and then welding or soldering the crimped upper tube end shut.

The invention discloses a way to design a current collector for an electrochemical sodium metal halide battery in order to achieve an axially symmetrical current distribution within the electrolyte material and uncomplicated filling of the cathode components and a technologically simple and inexpensive production of the current collector as well as its assembly in the electrochemical battery. An increased surface area of the current collector reduces contact resistance to metallic components of the cathode, thus reducing the internal resistance or power dissipation of the battery and increasing its performance.

### BRIEF DESCRIPTION OF THE DRAWINGS

The invention will be explained in more detail below with reference to exemplary embodiments and drawings. In the Figures:

FIG. 1 shows a schematic principle diagram of a cathode-side current collector according to the invention, made from a sectionally pressed metal tube with punched holes;

FIG. 2 shows a further embodiment of the cathode-side current collector of FIG. 1, with round punched holes through which tufts of metal wire pass;

FIG. 3 is a schematic sectional view of detail A of FIG. 1 with a continuous punched hole at the transition from the filler tube to the pressed tube section of the current collector;

FIG. 4 is a schematic representation of the current distribution in the cathode chamber within the radial plane B marked in FIG. 2, which intersects a hole with an inserted metal wire tuft in the pressed tube section of the current collector;

FIG. 5 shows a preferred embodiment example of the electrochemical sodium metal halide battery with a separator made of sodium B-aluminate and a cathode-side current collector made of nickel-plated copper tube;

FIG. 6 shows a further embodiment of the current collector according to the invention after pressing the metal tube with the crimped edge removed on one side, preferably for inserting a carbon felt;

FIG. 7 shows the embodiment of the current collector of FIG. 6 after the cathode materials have been filled in, with the upper end of the filler tube finally crimped and fused;

FIG. 8 shows a further embodiment of the current collector according to the invention with the upper tube end of the filler tube finally crimped and fused, the lower pressed tube section of the metal tube being centrally compressed from several non-parallel radial directions;

FIG. 9 shows a cross-section of the embodiment of the current collector shown in FIG. 8, in which the lower pressed tube section is pressed from four orthogonal radial directions, two of which are directed collinearly opposite to the tube axis in each case.

FIG. 10 shows a further embodiment of the current collector according to the invention as shown in FIG. 8, in which the filler tube with a finally crimped upper tube end is attached to a metal tube pressed separately from four orthogonal radial directions as a lower tube section, with cross-sectional differences between the filler tube and the radially pressed metal tube replacing the punched holes for the filling openings;

FIG. 11 shows the further embodiment of the current collector according to the invention with filler tube, pressed tube section and metal tube fitted with radial fins, which has a reservoir for the secondary electrolyte inside;

FIG. 12 shows another embodiment of the current collector shown in FIG. 11, in which the fins are replicated by an equidistantly folded metal sheet and the metal tube is replicated by the axially symmetrically bent metal sheet;

FIG. 13 shows a section of an expanded double cell arrangement of the electrochemical battery compared to FIG. 5, with a double-walled separator containing the anode chamber, and inner and outer cathode chambers with respective current collectors.

### DETAILED DESCRIPTION

In an exemplary basic construction, an electrochemical sodium metal halide battery according to the invention comprises a cathode-side current collector 1, a cathode 2 made of sodium salt and another metal halide, a separator 3 which separates a cathode chamber 21 from an anode chamber 41 as a solid primary electrolyte, a secondary electrolyte 22 which intersperses the cathode chamber 21 with the current collector 1, an anode 4 and a housing 5 which represents the anode-side current collector.

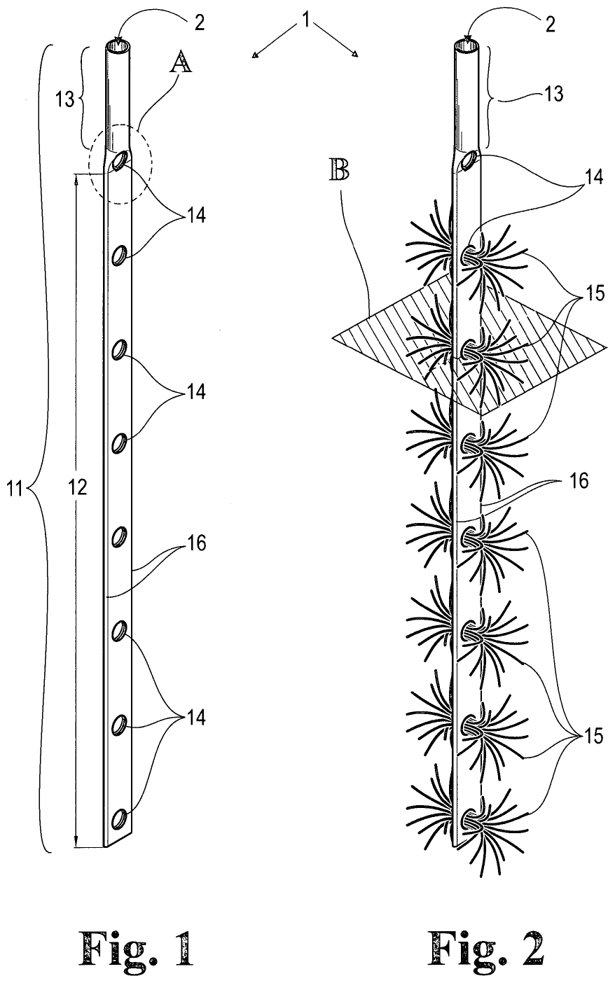

FIG. 1 shows a preferred embodiment of the cathode-side current collector 1, which, starting from a tubular base body (metal tube 11) made of a metal with good electrical conductivity (σ>10⁶ S/m), is divided into a lower pressed tube section 12, which extends in the cathode chamber 21 along the central axis 51 of the separator 3, and an upper unpressed tube section, which forms a filler tube 13 for the cathode material above the cathode chamber 21. The initially unpressed metal tube 11 and the remaining filler tube 13 may also be made to have square, polygonal, or corrugated cross-sections or otherwise deviate from a circular geometry in their cross-sections.

As much secondary electrolyte 22 is temporarily stored in the pressed tube section 12 as is required in the fully charged state for complete wetting of the porous cathode 2. The cathode 2 can replenish the liquid secondary electrolyte 22 from inside the current collector 1 during charging, during which the volume of the porous cathode granules is reduced by about 20%. For good electron conduction and thus reduced internal resistance of the Na/metal halide battery, the length of the current collector 1 should extend as far as possible up to the bottom of separator 3. Its length should therefore be chosen significantly greater than 70% of the length of the separator 3. Tubular Na/metal chloride batteries are advantageously manufactured with lengths between 50 mm and 500 mm. The electrical storage capacity is determined by the cathode chamber 21 filled with porous cathode 2 between the outer contour of the current collector 1 and the inner wall of the separator 3; thus, the diameter of the current collector 1 is to be selected particularly advantageously between 4 mm and 50 mm if the diameter of separator 3 is assumed to be 15 mm to 90 mm. If elements for surface enlargement are also attached to the current collector 1, as described in more detail below, adapted diameters of 10 mm to 80 mm of the outer contour of the current collector 1 can also be used for the assumed diameters of the separator 3.

Nickel or nickel alloys or even molybdenum can be used as materials for the current collector 1. For more cost-effective manufacture of the current collector 1, commercially available metal tubes 11 from mass production, e.g. made of copper or a copper alloy, are advantageously used, which are above all easy to form (pressing, punching, bending), are inexpensive and reduce the resistance of the electrochemical battery due to very high electrical conductivity.

For cell chemistry reasons, after the metal tube 11 is formed and slots or through-holes 14 are punched, the current collector 1 is protected from chemical erosion by a nickel coating. If, for example, a cathode 2 with ZnCl₂ or FeCl₂ granules is used, the current collector 1 may well be made of copper, if the battery voltage is chosen lower than the voltage (approx. 2.6 V) above which the copper reacts with the salt via the secondary electrolyte 22 to form CuCl or CuCl₂. However, the use of nickel or molybdenum as a protective layer is a reliable way to protect the current collector 1 from erosion, so that even aluminum tubes can be used. However, other material combinations can be selected depending on the cell chemistry (e.g. CuCl, CoCl₂, CrCl₂ or ZnCl₂).

If metal tufts 15 in the form of metal strips or metal wires of, for example, nickel or molybdenum are additionally introduced into the manufactured through-holes 14 (e.g. punched before, during or after pressing) of the metal tube 11, the surface area of the current collector 1 is considerably enlarged and, in particular in the case of a flat-pressed tube section 12, is approximated to a cylindrical outer contour. Instead of metal wires, rods (not shown) can be used equivalently. By using molybdenum instead of nickel, the maximum charging voltage can be higher when using a cathode 2 made of FeCl₂, for example, and the performance of the battery can be additionally increased by even better conductivity (Mo: 18.2·10⁶ S/m; Ni: 13.9·10⁶ S/m).

By varying the wire lengths of the metal tufts 15, their diameter, number and orientation, a very uniform resistance reduction of the cathode 2 in the cathode chamber 21 towards the separator 3 can be achieved.

The performance of the battery can be significantly influenced either by reducing the number and size (wire lengths and diameters) to a minimum and thus optimizing the Na/MCl₂ battery for storage capacity, or by using many wires of the metal tufts 15 adapted to the cathode chamber 21, which consequently leads to a reduction in capacity but increased performance. Metal tufts 15 reaching close to the separator 3 also mean that the electrons no longer take the path via the individual metal particles in contact with each other—as is common in the prior art—but can be transported rapidly via the wires of the metal tufts 15 as a solid, since in the charged state the amount of non-chlorinated, electrically conductive metal is reduced and the charging or discharging reaction always starts at the shortest distance from the separator 3.

As an embodiment example, a metal tube 11 approx. 300 mm long and 5 mm in diameter is assumed, resulting in an active surface area (which is in contact, at a height of 270 mm, with the cathode 2) of approx. 42.6 cm². If the metal tube 11 is provided with thirteen through-holes 14 and each through-hole 14 (except for the top through-hole 14 on the filler tube 13) is provided with metal tufts 15, each consisting of thirteen wires 0.7 mm thick and approx. 32 mm long, the surface area of the metal tufts 15 is an additional 110 cm², or even 160 cm² if the wires are 1 mm thick, with the added advantage that the fast electron injection paths (wires) extend up to the separator 3. By this embodiment example of shaping the current collector 1, the surface area of the cathode side current collector 1 can be increased by a factor of five (from approx. 40 cm² to 200 cm²). Instead of metal wires, sheet metal strips can also be attached, joined or pressed into or onto the metal tube 11.

For sufficient current stability, the material cross-section of the metal tube 11 must be adjusted according to the requirements.

If pressing, spreading or bending with possibly additional coating of the wires or sheets of the metal tufts 15 with the pressed tube section 12 is not sufficient to fix them against slipping out or to sufficiently reduce the contact resistance, it is possible to fix them with a welding or soldering process. A material with a lower conductivity than copper can also be used as the base material for the wires, rods or metal sheets of the metal tufts 15, in order to then provide them, together with the pressed tube section 12, with a chemically resistant protective layer, e.g. of nickel, molybdenum, if the cell chemistry and thus the charging voltage is adjusted accordingly. Base materials made of copper or nickel, for example, can also be coated with graphene to further increase conductivity.

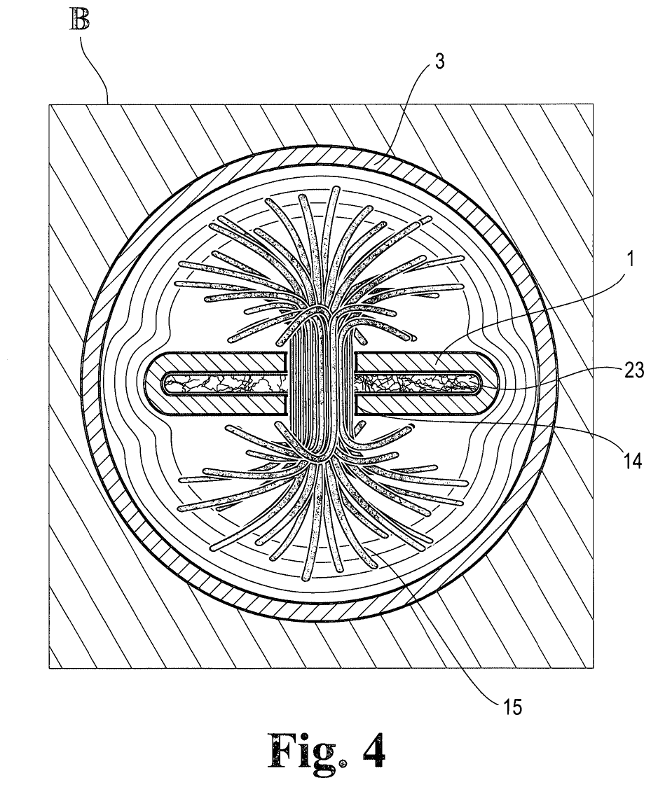

The measure of using metal tufts 15 (preferably made of metal wires) for surface enlargement in the case of a pressed current collector 1 entails yet another significant advantage, which consists in the fact that the current distribution in a preferably used cylindrical separator 3 is more homogeneous, because differences in radial resistance gradients resulting from the flat shape of the pressed tube section 12 are minimized or distributed more uniformly around the central axis 51. Such a homogenized current distribution of the current collector 1 according to the invention within a cylindrical separator 3 is shown qualitatively in FIG. 4. A similar behavior of the current distribution is achieved with a star-shaped pressing of the metal tube 11 for the current collector 1 as shown in FIG. 9. Furthermore, the pressed shape of the metal tube 11 can also be adapted to the contour of the separator 3.

The most uniform current density distribution within the cathode chamber 21 which can be generated in a rotationally symmetrical separator 3 is ensured by a current collector 1 in the form of an unpressed metal tube 11, which is also round and arranged centrally in the cathode chamber 21. This metal tube 11 can then be pressed only in an upper pressed tube section 12, which is only a few millimeters long, so that the area designated as the filler tube 13 for filling the cathode chamber 21 and, at the same time, the inner volume of the current collector 1 as a reservoir 24 for the secondary electrolyte 22 remains free below the pressed tube section 12. The current collector 1 in tubular form can then either be pressed shut in the lowest end region to such an extent that only the molten salt of the secondary electrolyte 22 can penetrate into the secondary electrolyte reservoir 24, or the metal tube 11 is pressed so lightly a few centimeters above the lowest end region that a carbon felt 23 can be inserted up to this stop and prevents the penetration of cathode 2 filled in as granules, for example.

In another embodiment, the carbon felt 23 is positioned up to the pressed tube section 12, which is a few millimeters long, in the area A inside the current collector 1, so that the carbon felt 23 protrudes from or terminates with the metal tube 11. The metal tube 11 need not have a self-contained contour, but need only ensure that the reservoir 24 is infiltrated with the secondary electrolyte 22 and that no granules of the cathode 2 can enter. Thus, slots along or across the center axis of the metal tube 11 are also permissible, but not in the filler tube 13 in the area of the cathode closure part 61 to outside the battery (because of the required cell tightness).

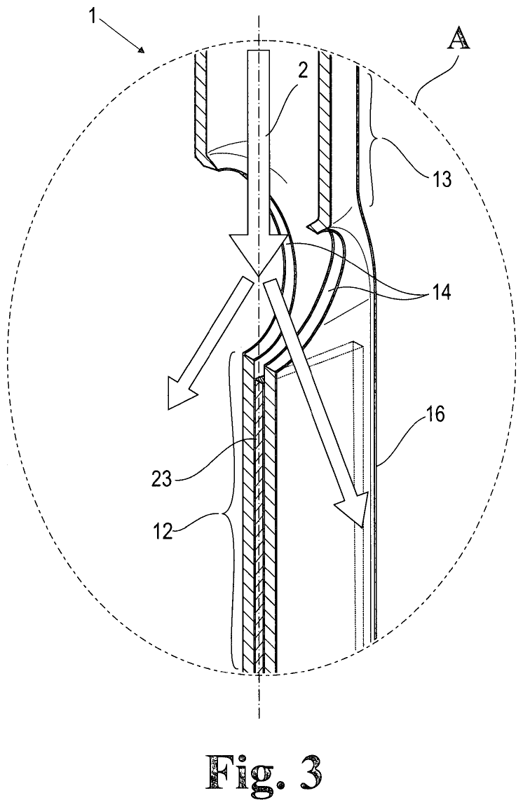

In a further embodiment, the metal tube 11 can be filled with a rolled-up carbon felt 23 prior to pressing to such an extent that a cavity remains only in the upper tube section, the filler tube 13. Subsequently, the current collector 1 provided with a carbon felt 23 is pressed and perforated in the metal tube 11 later in contact with the cathode 2 and preferably—according to the embodiment of FIG. 2—provided with metal tufts 15 of metal wires, with the top through-hole 14 in the transition area between the pressed tube section 12 and the filler tube 13 remaining free, i.e. no metal tuft 15 is inserted, because this through-hole 14—as can be seen in FIG. 3 from the enlarged detail A of FIG. 1—is provided for filling with the granules of the cathode 2 and subsequently for the liquid infiltration of the secondary electrolyte 22.

It is possible for the pressed tube section 12 or an unpressed metal tube 11 to have at least one additional through-hole 14, below the top through-hole 14 provided for cathode filling, which does not include metal tufts 15, so that the secondary electrolyte 22 from the carbon felt 23 or from the reservoir 24 in the unpressed metal tube 11 can additionally escape from the interior of the current collector 1 to uniformly wet the granules of the cathode 2.

Instead of pressing the metal tube 11 of the current collector 1 flat, additional structures can also be stamped into the metal (undulations, grooves, channels, slots, etc.) to increase the surface area.

The filling process of the cathode 2 as a mixture of granulated metal powders, such as nickel, iron, aluminum, but also copper, cobalt, chromium or zinc, which are not converted to metal halides until subsequent charging of the battery, and a sodium halide, for example sodium chloride, iodide, bromide or fluoride, is then carried out in the manner schematically shown in FIG. 3 by pouring in the metal and metal halide powders in the form of pressed granules. The granules of the cathode 2 then hit the pressed tube section 12 and are deflected laterally through preferably two openings of the unpressed top through-hole 14. For good flowability, the dimensions of the through-hole 14 or further through-holes 14 in the filler tube 13 must be adapted to the granule size of the cathode 2.

The larger the surface area of the cathode-side current collector 1 is, the lower the contact resistance between the porous metal network (formed, for example, by non-chlorinated nickel or iron in the cathode granules) and the current collector 1 will be.

If, for the above purpose, the current collector 1 were to be formed as a metal tube 11 of increased diameter, with the inner cavity of the metal tube 11 being available as a reservoir 24 of the secondary electrolyte 22, its electrically conductive surface area would also increase, but storage capacity would then be unnecessarily reduced because, above a certain inner volume of the metal tube 11, more secondary electrolyte 22 would be stored in the reservoir 24 than would be necessary for the charging process, and the cathode chamber 21 remaining for the granules of the cathode 2 would be reduced.

The invention therefore provides, as an expedient design of the cathode-side current collector 1, a reduced inner volume and an increase in surface area, as well as a shape of the outer contour that is spatially adapted to the separator 3, assumed to be cylindrical.

In a preferred embodiment, formed by a flat pressed tube section 12 with through-holes 14 and metal tufts 15 of metal strips or wires inserted therein, as shown in plane B of FIG. 2 from the sectional view of FIG. 4, the metal strips or metal wires inserted as pressed tufts into the through-holes 14 can be adapted to a cylinder-like outer shape of the current collector 1 by subsequent fanning and upsetting, resulting in a uniform radial resistance distribution in the cathode chamber 21 of the separator 3.

The diameter of the metal tube 11 is determined by the size and flowability of the granules of the cathode 2 or the diameter of the through-holes 14 formed as a filling opening, which is required for a filling time to be observed. However, the through-holes 14 used for the surface enlargement of the current collector 1 may differ therefrom. By varying the wire lengths, diameters, their number and orientation, a very uniform, accurate resistance reduction can then be achieved in the cathode 2.

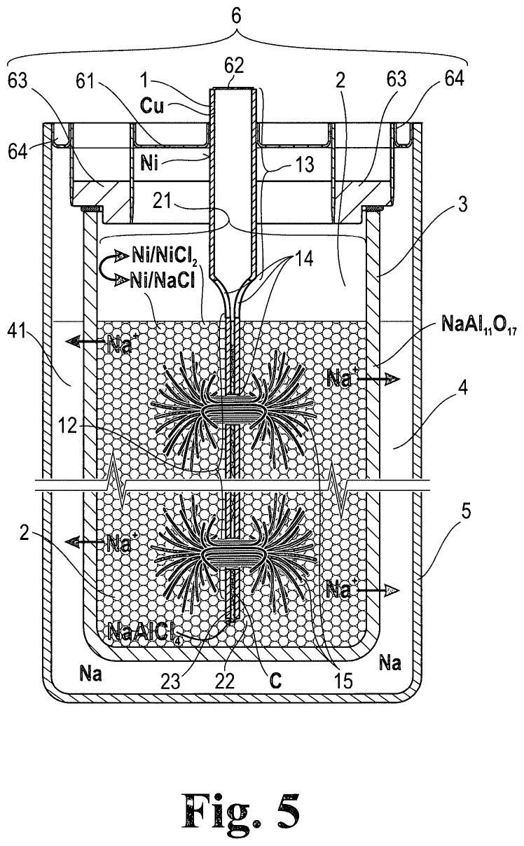

FIG. 5 shows a preferred embodiment of the electrochemical battery according to the invention as a schematic representation (not to scale) of an axial section of the battery. In the drawing, the main components of the electrochemical battery are shown in a principal spatial arrangement and these are designed as a specific embodiment embodiment example in terms of special cell chemistry.

In the design of the battery shown in FIG. 5, the cathode-side current collector 1 is made of a copper tube provided with a nickel coating to increase chemical resistance. The use of copper or aluminum as the base material of the metal tube 11 lowers the electrical resistance of the current collector 1 due to the higher electrical conductivity, and due to the thin-walled hollow structures and a cathode 2 manufactured in comparison to a pure nickel solid, the manufacturing costs are reduced and the forming (pressing and punching) is simplified, since the wall thicknesses are smaller than those of a non-hollow body despite the larger surface area. In an alternative embodiment, however, the current collector 1 may be made entirely of nickel.

As an alternative to the cell structure shown in FIG. 5, the cathode 2 can also be arranged outside the separator 3. It can then be arranged either exclusively outside the separator 3, i.e. inverted (not shown) in comparison with the structure of FIG. 5, or in the case of a double-walled design of the separator 3 with enclosed anode chamber 41—as shown in FIG. 13—both inside and outside this double-walled structure of the separator 3, as is known in principle from WO 2018/138740 A1.

The cathode-side current collector 1, made of a nickel-plated copper tube as shown in FIG. 5, is manufactured in the shape shown in FIG. 2 and is aligned collinearly with the axis of the separator 3. The separator 3 divides the inner volume of the housing 5 acting as an anode-side current collector into an outer anode chamber 41, which in this example is filled with metallic sodium as the anode 4 in the charged state, and the inner cathode chamber 21, which in this embodiment example is filled with granules of nickel/NaCl (uncharged state) or nickel/NiCl₂ (fully charged state), which have been poured in through the upper tube section, the so-called filler tube 13 of the current collector 1. To ensure rapid filling of the cathode chamber 21 with cathode granules and also to achieve low internal resistance, the cross-section of the metal tube 11 and the through-hole 14 must be matched to the volume of the cathode 2 and the overall battery dimension.

In this embodiment of FIG. 5, the pressed tube section 12 of the current collector 1 is provided with metal tufts 15 of metal wires in the punched through-holes 14. The metal tufts 15 used for surface enlargement may be nickel or molybdenum wires. The through-holes 14 can be punched, for example, before, during or after pressing the metal tube 11, in order to subsequently fill them additionally with metal tufts 15, e.g. of nickel or molybdenum, and thus considerably increase the surface area of the current collector 1. Gold-plating the current collector 1 and its metal tufts 15 would again lower the resistance of the current collector 1, but increase the manufacturing costs.

Furthermore, the cathode chamber 21 within the separator 3, which is a solid primary electrolyte made of sodium β-aluminate, is filled with a liquid secondary electrolyte 22, which in this example is sodium tetrachloroaluminate (NaAlCl₄). To ensure that only the secondary electrolyte 22 and no Ni/NaCl granules can enter the interior of the current collector 1 below the filler tube 13, the metal tube 11 contains either a carbon felt 23 on the inside, which was inserted and pressed into the metal tube 11 before pressing, or the gap dimensions of the pressed tube section 12 below the filler tube 13 and the bottom end of the pressed tube section 12 are sufficiently small.

The assembly of the cathode-side current collector 1 in the electrochemical battery can advantageously be carried out as a one-step joint, which is performed at different atmospheres and temperatures in suitable furnaces, depending on the design. In one-step joining, the ceramic-ceramic bond between the separator 3 and the ceramic insulator joining ring 63, which may be made of corundum, for example, and the metal-ceramic bond between the separator 3 and a metallic cathode closure part 61 and a metallic anode closure part 64 for hermetically sealing the electrochemical battery are completed in a single joining step. For this purpose, the metallic closure parts 61 and 64 are advantageously manufactured by deep drawing. The cathode closure part 61 closing the cathode chamber 21 is provided with a central opening into which the current collector 1 is inserted with one of the embodiments according to the invention, for example with the pressed tube section 12 provided with metal tufts 15, and is welded or soldered to the unpressed tube section, the filler tube 13, before joining. In another embodiment, the filler tube 13 is soldered to the metallic cathode closure part 61 during the one-step joining process or is welded to it only after the joining process.

During the joining step of the one-step joining process, the separator 3 surrounding the cathode chamber 21 or, for example, the housing 5 with its dimensions determines the required clearances in the furnace. Thus, positioning the current collector 1 inside the separator 3 does not increase the required clearance and is not a disadvantage.

During the one-step joining process, the anode closure part 64 is also joined as a further, e.g. deep-drawn, metal part to the insulator joining ring 63 at a suitable point; the housing 5 (as anode-side current collector) can also be welded to the metallic anode closure part 64 following the joining process, thus forming the hermetically sealed anode chamber 41. If a carbon felt 23 has been introduced into the current collector 1, the preferably one-step joining or high-temperature soldering process can only be carried out in the absence of oxygen, as otherwise the carbon will be oxidized. Following the welding processes associated with the one-step joining, the electrochemical battery has only a single opening, namely the open tube end of the filler tube 13 of the cathode-side current collector 1, or a plurality of openings in the case of multiple current collectors 1,1′. The granular mixture of the cathode 2 is introduced into the cathode chamber 21 of the electrochemical battery via this opening of the feed tube 13. In the absence of oxygen and water, e.g. under vacuum or by inert gas purging, the secondary electrolyte 22 is then introduced in liquid form into the cathode chamber 21 of the battery through the same opening of the filler tube 13. Finally, the opening of the battery is then welded shut—e.g. with a deep-drawing part or a circular sheet metal blank 62 for closing the upper tube end of the filler tube 13—at the protruding end of the current collector 1.

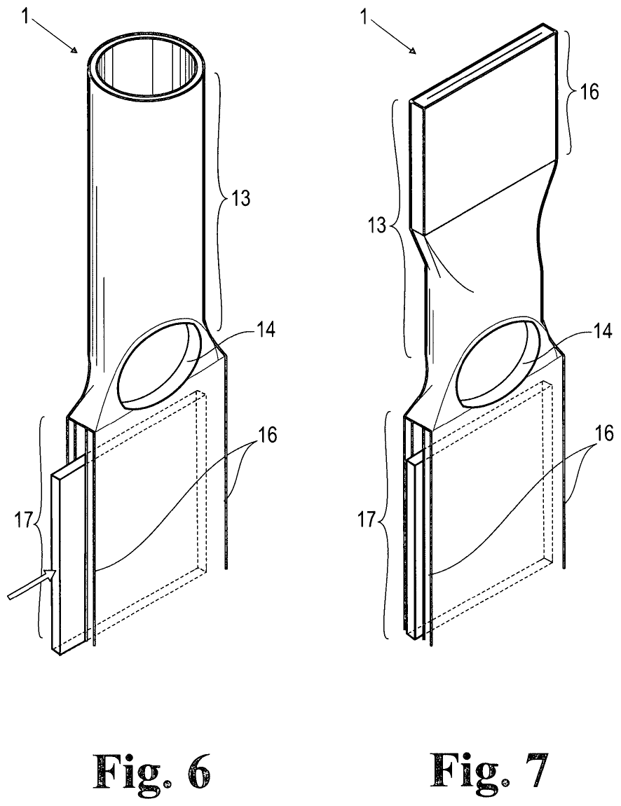

In another embodiment of the final battery assembly, shown schematically in FIGS. 6 and 7, the filler tube 13 of the current collector 1 protrudes so far from the cathode closure part 61 that it is squeezed off outside the finished filled battery and the narrow end face that forms can be welded shut directly.

In FIGS. 6 and 7, yet another modification of the current collector 1 is shown, which serves to insert the carbon felt 23 into the metal tube 11 even after the latter has been pressed.

For this purpose, after the pressed tube section 12 has been produced, a crimped edge 16 is opened, for example by cutting or milling, so that a strip-shaped carbon felt 23 can be introduced through the laterally removed crimped edge 17.

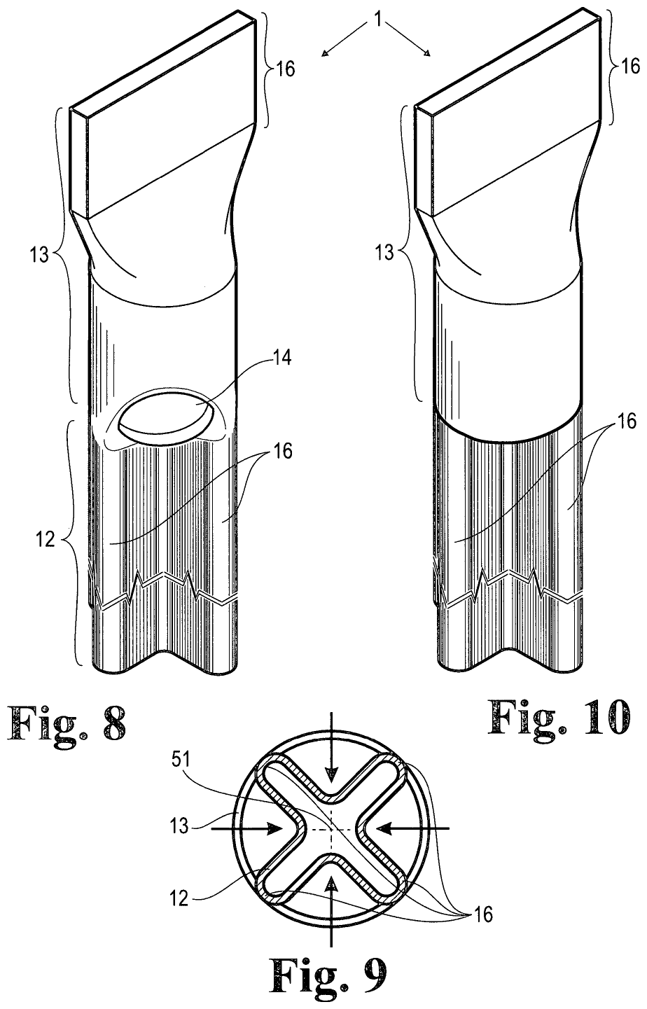

Another embodiment of the current collector 1 is shown in FIGS. 8 and 9. In this embodiment, to increase the surface area of the metal tube 11 (designated only in FIG. 1), the pressed tube section 12 of the current collector 1 has been pressed in four radial directions with respect to the central axis 51, two directions of which are collinearly opposed in each case. As a result, the cross-section of the pressed tube section 12 is star-shaped, as shown in FIG. 9.

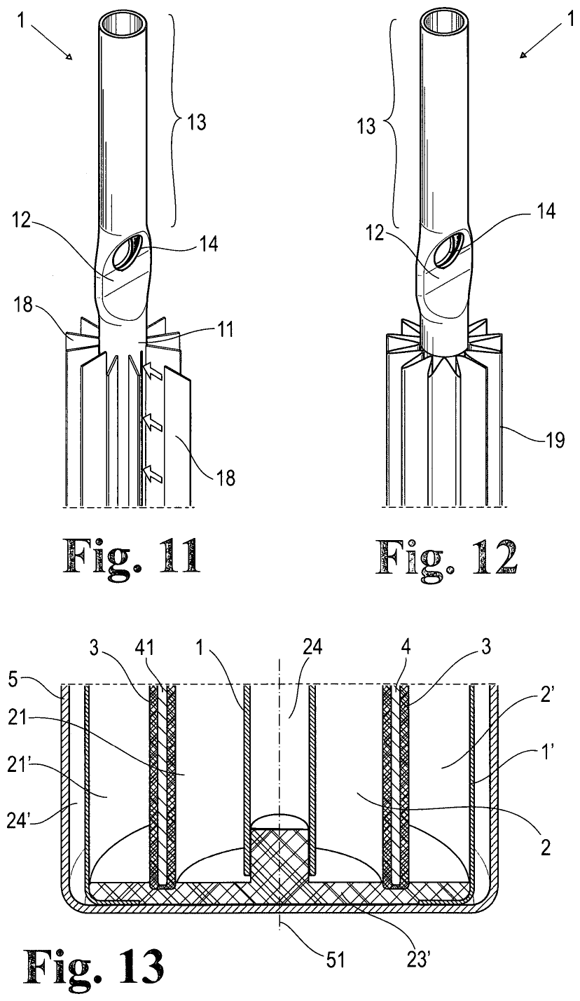

As other alternative cross-sections, the star shape can also be three-pointed, five-pointed, six-pointed, etc. (not shown). Although not shown in FIG. 8, through-holes 14 with metal tufts 15 or slots with metal sheets, as shown in FIG. 11, can also be additionally introduced in this example to further increase the surface area.

Another modification for creating a star-shaped cross-section of the pressed tube section 12, shown in FIG. 10, can be performed by first creating a metal tube 11 in a star shape, as visible in FIG. 9, and then welding the unpressed tube section onto the pressed tube section 12 as a filler tube 13. As a result, four through-holes 14 for filling the cathode granules are created automatically by means of the deviating cross-sectional shapes of the pressed tube section 12 and the cylindrical filler tube 13 and do not have to be punched in this case. To prevent Ni/NaCl granules from entering the interior of the pressed tube section 12, the upper pressed section and the lower opening of the current collector 1 can be manufactured to a sufficiently small gap size, or a carbon felt 23 can be inserted for sealing.

In a further embodiment of the current collector 1 advantageously positioned axially in the cathode chamber 21 according to the embodiment example shown in FIG. 11, a tubular base body (metal tube 11) made of a metal that is a good conductor of electricity is divided into a lower pressed tube section 12 and an upper unpressed tube section, the filler tube 13, for filling the cathode chamber 21. Through the pressed tube section 12, the cathode 2 can only be filled into the cathode chamber 21 via a through-hole 14 without entering the secondary electrolyte reservoir 24 inside the metal tube 11. Through slots in the metal tube 11 below the pressed tube section 12, fins 18 made of embedded metal sheets can be inserted additionally, which are welded, pressed or soldered to the metal tube 11. The fins 18 can be continuous, individually attached or formed in such a way that a metal sheet inside is adapted to the contour of the metal tube 11 and thus forms at least two fins 18.

In a further embodiment according to FIG. 12, the fins 18 can also be formed only by a meandering folded metal sheet 19.

As can be seen in FIG. 12, a star-shaped or wavy cross-sectional contour of the secondary electrolyte reservoir 24 can also be formed from a folded metal sheet 19, which is then welded, soldered or pressed to the metal tube 11 of the current collector 1 divided into the open filler tube 13 and the pressed tube section 12. For this purpose, the folded metal sheet 19 can first be manufactured with fin-like structures and then bent into a structure manufactured internally, e.g. as a tubular shape, and connected to a fin 18. Instead of one folded metal sheet 19, several folded metal sheets 19 can be used for forming. The gap dimensions between the fins 18 formed must be small enough to prevent any cathode 2 from entering the secondary electrolyte reservoir 24. Even in the case where the internal dimensions of the resulting star-shaped cross-sectional contour are smaller or larger than the lower opening of the metal tube 11, the secondary electrolyte reservoir 24 must nevertheless remain free of granules of the cathode 2 and the remaining openings must be closed sufficiently tightly, e.g. by further pressing at least the lower end of the metal tube 11, or one or more carbon felts 23 must be inserted.

FIG. 13 shows another measure for increasing the power of the electrochemical battery, which is designed as a radial double cell. In this case, a further current collector 1′ is provided for contacting a further cathode 2′ in the space between the housing 5 and the outer wall of a separator 3 with double walls in this example, which contains the anode chamber 41 for the anode 4 in a cylindrical annular gap. The current collector 1′, which is advantageously used in addition to the current collector 1 positioned in the central axis 51 as an unpressed metal tube 11 (not designated in FIG. 13), is also used to substitute the carbon felt 23 by forming the secondary electrolyte reservoir 24′ between the current collector 1′ and the inner wall of the housing 5, while at the same time preventing direct contact of the granules of the further cathode 2′ with the housing wall, but providing electrical contact via the current collector 1′, thereby reducing the electrochemical corrosion wear on the actual housing 5. Similarly, in the design of the further current collector 1′, its surface area can also be further increased either by also adding additional folded metal sheets 19 aligned with the central axis 51 or by the sheet metal strips themselves having a design similar to the housing contour and forming fins 18 aligned with the central axis 51.

In this case, when using the additional current collector 1′, manufactured, for example, as a metal tube 11 made of nickel or, depending on the cell chemistry, also of nickel-plated copper, with a diameter smaller than the inside diameter of the housing 5, the further secondary electrolyte reservoir 24′ can be created in such a way that at the same time the electrochemically active cathode 2′ is electrically contacted and a carbon felt 23 over the filling level of the cathode 2′ can be dispensed with. A further carbon felt 23′ positioned in the bottom area of the housing 5 prevents direct contact of the granules of the cathode 2 with the wall of the housing 5.

The further current collector 1′ positioned in the outer area of the further cathode chamber 21′ can also be formed by sheet metal strips bent over in the bottom area of the housing 5 instead of a tube flanged at the bottom, by being directly connected (e.g. spot welding, soldering) to the bottom of the housing 5, which is either a component that is separate from the housing 5 or has been produced in one piece by deep drawing the housing 5. In order to further reduce the contact resistance of the further current collector 1′ to the housing 5, the individual sheet metal strips of the further current collector 1′ can be manufactured to excess length in such a way that they are each additionally bent over and then allow further, flat contact with the inner wall of the housing 5 (not shown in the drawing).

Alternatively, welding of the current collector 1′ in the upper closure area of the battery to the housing 5 or other parts of the closure area is possible. For the current collector 1, all variants as described above remain possible. Preferably, however, the configurations of FIGS. 11 and 12 can be used.

The invention provides a particularly low-cost electrochemical battery composed of few parts that are easy to manufacture and assemble. In particular, the novel shape of the current collector 1 allows the battery to be easily and effectively filled with the metal granules of the cathode 2 and the secondary electrolyte 22 after the battery is already fully assembled and hermetically welded. The possibility of manufacturing the current collector 1 monolithically and enabling contacting from one battery to the next directly with the pressed and welded filler tube 13 eliminates joining processes, and the contact resistance can be additionally reduced. By keeping the current collector 1 in a separate inner volume, inaccessible to the Ni/NaCl granules but readily infiltratable by the secondary electrolyte 22, the function of the carbon felt 23 as a secondary electrolyte reservoir 24 can be substituted. Furthermore, the special type of surface enlargement of the current collector 1 achieves a more uniform radial current distribution in the cathode chamber 21.

### LIST OF REFERENCE NUMERALS

1, 1′ (cathode-side) current collector
11 metal tube
12 pressed tube section
13 filler tube/unpressed tube section
14 punched opening/through-hole
15 metal tuft (made from metal strips or wires)
16 crimped edge
17 removed crimped edge
18 fin
19 folded metal sheet
2, 2′ cathode
21, 21′ cathode chamber
22 secondary electrolyte
23,23′ (carbon) felt
24, 24′ (secondary electrolyte) reservoir
3 separator (solid primary electrolyte)
4 anode
41 anode chamber
5 housing
51 central axis
6 battery closure
61 (metallic) cathode closure part
62 circular sheet metal blank
63 (ceramic) insulator joining ring
64 anode closure part

1. An electrochemical sodium metal halide battery, comprising:
a housing with a central axis,
a separator extending about the central axis of the housing equidistantly from the housing, which separator, as a solid primary electrolyte, electrically insulates and hermetically separates an anode chamber from a cathode chamber, but is permeable to sodium ions,
a cathode filling the cathode chamber and consisting of a porous mixture of metal powder and metal halide powder granules, as well as a secondary electrolyte of molten sodium metal halide salt impregnating the cathode chamber and the porous mixture of the cathode, and
a cathode-side metallic current collector elongated about the central axis in the cathode chamber,
wherein:
the current collector is a metal tube having a high electrical conductivity of σ>10⁶ S/m, which is immersed in the porous mixture of granules of the cathode located in the separator and in the secondary electrolyte and is designed as a pressed tube section which is narrowed on the inside in such a way that no granules of the cathode but only secondary electrolyte can penetrate, and is provided on the outside with elements for increasing a surface area of the current collector, and
the current collector has, above the immersed, pressed tube section, an unpressed tube section as a filler tube for filling the cathode chamber, wherein at least one through-hole opening the filler tube to the outside is provided at a transition from the pressed tube section to the unpressed tube section of the filler tube, such that the filler tube is configured to be used for filling the porous mixture of granules of the cathode into the cathode chamber only outside the pressed tube section and for filling the entire cathode chamber with secondary electrolyte.

2. The electrochemical battery according to claim 1, wherein the current collector has a carbon felt in the pressed tube section that was inserted into the pressed tube section before pressing.

3. The electrochemical battery according to claim 1, wherein the current collector has a carbon felt in the pressed tube section that is laterally insertable into the pressed tube section after pressing and removal of a crimped edge of the pressed tube section.

4. The electrochemical battery according to claim 1, wherein the current collector has punched holes in the pressed tube section in the form of further through-holes.

5. The electrochemical battery according to claim 4, wherein the current collector has metal tufts of metal strips or wires in the pressed tube section, which are fastened in the through-holes and made of a metal not attacked by the electrochemical processes of the battery and having a conductivity comparable to that of the metal tube of the current collector.

6. The electrochemical battery according to claim 1, wherein a commercially available nickel, aluminum or copper tube is used as the current collector.

7. The electrochemical battery according to claim 1, wherein, in the current collector, the elements for surface enlargement are formed with at least one element from the group of punched through-holes or other relief-forming structures with crimped edges, metal tufts, fins or folded metal sheets.

8. The electrochemical battery according to claim 5, wherein the metal tufts of metal strips or wires are made of nickel or molybdenum.

9. The electrochemical battery according to claim 5, wherein the metal tufts of metal strips or wires are oriented so that local resistance gradients in the cathode chamber are minimized or uniformly distributed across the cross-section of the cathode chamber.

10. The electrochemical battery according to claim 5, wherein the metal strips or wires used in the metal tufts have a length which is selected to be smaller the higher the capacities of the battery to be achieved are and to be larger, up to the separator at maximum, the higher the powers to be extracted from the battery are.

11. The electrochemical battery according to claim 1, wherein, after the porous mixture of the cathode and the secondary electrolyte have been filled, the unpressed tube section of the filler tube of the current collector is sealed with a cohesively bonded circular sheet metal blank or a deep-drawn part.

12. The electrochemical battery according to claim 1, wherein, after the porous mixture of the cathode and the secondary electrolyte have been filled, the unpressed tube section of the filler tube of the current collector is crimped or hermetically sealed with a soldered or welded seam at the upper tube end of the filler tube.

13. The electrochemical battery according to claim 1, wherein the pressed tube section of the current collector is pressed flat from two collinear directions.

14. The electrochemical battery according to claim 1, wherein the pressed tube section of the current collector is pressed from at least three directions equally offset about the central axis to form a star-shaped cross-section.

15. The electrochemical battery according to claim 13, wherein the pressed tube section of the current collector is pressed by force effects in such a way that an interior space forming as a secondary electrolyte reservoir is just as large as a volume of the secondary electrolyte which is necessary for complete wetting of the current collector in the fully charged state of the battery.

16. The electrochemical battery according to claim 1, characterised in that a metal tube (11) is added below the pressed tube section (12) of the current collector (1), which metal tube (11) is fitted with radial fins (18) inserted into tangentially equidistant slots of the metal tube (11).

17. The electrochemical battery according to claim 1, wherein a metal tube with radial fins is added below the pressed tube section of the current collector, which metal tube is produced from an equidistantly folded metal sheet and its axially symmetrical bending.

18. A method for manufacturing an electrochemical sodium metal halide battery comprising the steps of:
providing a housing for forming an anode chamber, a separator insertable equidistantly from the housing as an electrically insulating solid primary electrolyte permeable only to sodium ions for separating the anode chamber from a cathode chamber, a cathode comprising a porous mixture of metal powder and metal halide granules, and a secondary electrolyte for impregnating the porous mixture of the cathode,
producing a cathode-side current collector from a metal tube which is formed, by forces acting radially on a central axis, into a compressed tube section of the current collector and in which an unpressed tube section remains at the upper end as a filler tube, at least one through-hole being made at least at a transition from the pressed tube section to the filler tube, which through-hole is provided as an outlet opening of the filler tube for filling the cathode chamber,
producing a battery closure from a cathode closure part having a central opening for passage of the filler tube of the current collector in the central opening of the cathode closure part, and cohesively connecting the cathode closure part to an insulator joining ring as well as cohesively joining an anode closure part to the insulator joining ring,
positioning the current collector collinearly with the central axis in the separator as well as the housing arranged equidistantly around the separator by means of the battery closure consisting of the insulator joining ring and the anode closure part by a one-step joining process as well as cohesively connecting the joints,
filling the porous mixture of metal powder and metal halide powder granules of the cathode through the filler tube of the current collector and the at least one through-hole of the filler tube into the cathode chamber in the separator only outside the current collector, and then pouring the secondary electrolyte in liquid form in the absence of oxygen, and
finally hermetically sealing the electrochemical battery by cohesively closing the filler tube.

19. The method according to claim 18, wherein when producing the battery closure from the cathode closure part and the cohesively connected cathode closure part with the insulator joining ring and the attached anode closure part, the current collector is cohesively fixed in the central opening of the cathode closure part before positioning the current collector in the separator as well as the housing arranged collinearly with the central axis, by the battery closure consisting of the insulator joining ring and the anode closure part by a one-step joining process as well as cohesively connecting the joints.

20. The method according to claim 18, wherein when producing the battery closure from the cathode closure part and the cohesively connected cathode closure part with the insulator joining ring and the attached anode closure part, the current collector is positioned in the central opening of the cathode closure part and, after positioning the current collector, the current collector is fixed collinearly in the separator as well as in the housing arranged equidistantly about the separator and collinearly with the central axis through the one-step joining process, by the battery closure consisting of the insulator joining ring and the anode closure part, as well as cohesively connecting the joints.

21. The method according to claim 18, wherein when producing the battery closure from the cathode closure part and the cohesively connected cathode closure part with the insulator joining ring and the attached anode closure part, the current collector is cohesively fixed in the central opening of the cathode closure part before positioning the current collector in the separator collinearly with the central axis by the battery closure consisting of the insulator joining ring and the anode closure part, through the one-step joining process, and then positioning the housing, which is arranged equidistantly to the separator and collinearly to the central axis, and fixing the joints by cohesive connection.

22. The method according to claim 18, wherein elements for increasing the surface area of the current collector are introduced equidistantly into the pressed tube section in a form of through-holes.

23. The method according to claim 22, wherein metal tufts of metal strips or wire are inserted into the through-holes in the pressed tube section.

24. The method according to claim 18, wherein the pressed tube section of the current collector is formed flat by collinear radial force application.

25. The method according to claim 18, wherein the pressed tube section of the current collector is formed into a star shape by several radial forces distributed equally around the central axis.

26. The method according to claim 18, wherein, for surface enlargement of the current collector, radial fins are attached to a metal tube below the pressed tube section and are inserted into tangentially equidistant slots.

27. The method according to claim 18, wherein, for surface enlargement of the current collector, radial fins are produced on a metal tube below the pressed tube section by a folded metal sheet.

28. The method according to claim 18, wherein the filler tube is closed by welding or soldering the upper tube end to a circular sheet metal blank.

29. The method according to claim 18, wherein the filler tube is closed by crimping the upper tube end and finally welding or soldering the crimped upper tube end.
